(19) United States
(12) Patent Application Publication
(10) Pub. No.: US 2024/0192930 A1
(43) Pub. Date: Jun. 13, 2024

(54) Application Dependency Visualization

(71) Applicant: Bank Of America Corporation, Charlotte, NC (US)

(72) Inventors: Erik Dahl, Newark, DE (US); Pratap Dande, Saint Johns, FL (US); Rahul Yaksh, Austin, TX (US); Vishwanath Prasad Karra, Mckinney, TX (US); Steven Allan Reich, Manalapan, NJ (US); Tileshia Brenda Alford, Charlotte, NC (US)

(73) Assignee: Bank Of America Corporation, Charlotte, NC (US)

(21) Appl. No.: 18/063,741

(22) Filed: Dec. 9, 2022

(51) Int. Cl. G06F 8/36

(52) U.S. Cl. CPC G06F 8/36

(57) ABSTRACT

An application mapping engine may determine dependencies in existing executable application by monitoring and analyzing process flow and data flow of the application during runtime execution. The application mapping engine may generate dependency visualization maps that illustrate dependency interaction information.

### FIELD

Aspects described herein generally relate to computer systems and networks. More specifically, aspects of this disclosure relate to mapping of application dependencies and visually displaying those dependencies.

### BACKGROUND

Organizations may utilize hundreds or thousands of applications to conduct daily business transactions. These applications have many dependencies between each other that are extremely difficult to visualize. There is no common format, style, or system of record for application dependency diagrams for business services. As a result, diagrams are created in various formats, stored in multiple locations, are rarely updated, and almost always have to be redrawn from scratch in response to regulatory or executive requests.

The redrawing of dependency maps is time consuming and wasteful of system resources. Additionally, the current state presents risks of sharing or communicating out of date information, and requires error-prone interpretation of different diagram styles by different users or teams. There is a need to develop a system to generate and update application interface maps that removes wasteful resources and provides a common mapping style across an organization to enable rapid exchange and interpretation of information.

### SUMMARY

Aspects of the disclosure provide solutions that address and overcome technical problems associated with generating visual representations of interactions and/or dependencies between applications. The architecture may comprise application components (e.g., logic, functions, etc.), infrastructure components (e.g., computing and/or network services), and/or interconnections. As an application evolves over time, the dependencies between applications change and such changes need to be captured and documented.

Various aspects of this disclosure relate to devices, systems, and methods for mapping of application dependencies. An application mapping engine may determine dependencies in existing executable application by monitoring and analyzing process flow and data flow of the application during runtime execution. The application mapping engine may generate a dependency visualization map that leverages dependency interaction information along with existing sources of dependency information. The generated dependency visualization maps may be modified, annotated, and/or saved for further study. The system may include performing machine learning based on the generated visualization maps and the monitored process and data flow through the applications.

### BRIEF DESCRIPTION OF THE DRAWINGS

The present disclosure is illustrated by way of example and not limited in the accompanying figures in which like reference numerals indicate similar elements.

FIGS. 1 and 2 depict an illustrative computing environment for application dependency mapping of executable applications, in accordance with one or more example arrangements.

FIG. 3 illustrates an exemplary user interface feature selection background that may be used in accordance with various aspects of the disclosure.

FIG. 4 illustrates an exemplary application template that may be used in accordance with various aspects of the disclosure.

FIG. 5 illustrates additional exemplary application templates that may be used in accordance with various aspects of the disclosure.

FIG. 6 illustrates exemplary determined application dependencies between users and applications in accordance with various aspects of the disclosure.

FIG. 7 illustrates exemplary determined application dependencies between applications in accordance with various aspects of the disclosure.

FIG. 8 illustrates a dependency diagram showing all dependencies between applications and users in accordance with various aspects of the disclosure.

FIG. 9 illustrates using styles and colors to highlight features of application dependency diagrams in accordance with various aspects of the disclosure.

FIG. 10 illustrates a method of determining application dependencies in accordance with various aspects of the disclosure.

### DETAILED DESCRIPTION

In the following description of various illustrations, reference is made to the accompanying drawings, which form a part hereof, and in which is shown, by way of illustration, various examples in which aspects of the disclosure may be practiced. It is to be understood that other examples may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Various aspects of this disclosure relate to devices, systems, and methods for mapping of application dependencies. An application mapping engine may determine dependencies in existing executable application by monitoring and analyzing process flow and data flow of the application during runtime execution. The application mapping engine may generate a dependency visualization map that leverages dependency interaction information along with existing sources of dependency information (service enablers, server dependencies, information flows, product scans, application records etc.). The generated dependency visualization maps may be modified, annotated, and/or saved for further study. The system may include performing machine learning based on the generated visualization maps and the monitored process and data flow through the applications.

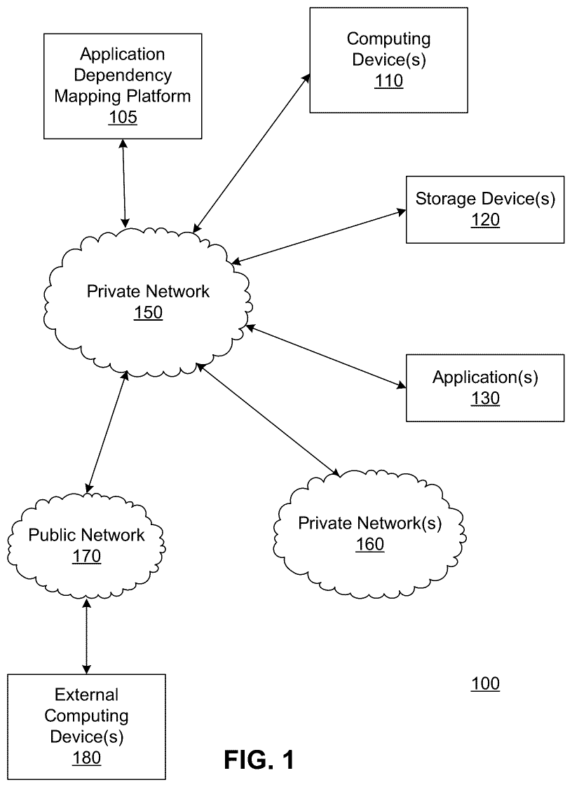

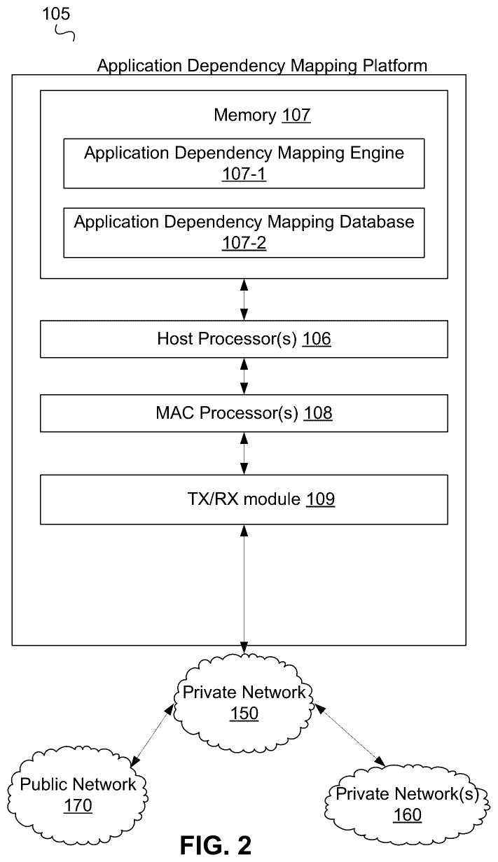

FIGS. 1 and 2 depict an illustrative computing environment for application dependency mapping of executable applications, in accordance with one or more example arrangements. Referring to FIG. 1, a computing environment 100 may comprise one or more devices (e.g., computer systems, communication devices, servers). The computing environment 100 may comprise, for example, an application dependency mapping platform 105, computing device(s) 110, and storage device(s) 120 linked over a private network 150. The storage device(s) 120 may comprise a database, for example, a relational database (e.g., Relational Database Management System (RDBMS), Structured Query Language (SQL), etc.). Application(s) 130 may operate on one or more computing devices or servers associated with the private network 150. The private network 150 may comprise an enterprise private network, for example.

The computing environment 100 may comprise one or more networks (e.g., public networks and/or private networks), which may interconnect with the application dependency mapping platform 105, the computing device(s) 110, the storage device(s) 120, and/or one or more other devices and servers. One or more applications 130 may operate on one or more devices in the computing environment. The networks may use wired and/or wireless communication protocols. The private network 150 may be associated with, for example, an enterprise organization. The private network 150 may interconnect the application dependency mapping platform 105, the computing device(s) 110, the storage device(s) 120, and/or one or more other devices/servers which may be associated with the enterprise organization. The private network 150 may be linked to other private network(s) 160 and/or a public network 170. The public network 170 may comprise the Internet and/or a cloud network. The private network 150 and the private network(s) 160 may correspond to, for example, a local area network (LAN), a wide area network (WAN), a peer-to-peer network, or the like.

A user in a context of the computing environment 100 may be, for example, an associated user (e.g., an employee, an affiliate, or the like) of the enterprise organization. An external user may utilize services being provided by the enterprise organization, and access one or more resources located within the private network 150 (e.g., via the public network 170). Users may operate one or more devices in the computing environment 100 to send messages to and/or receive messages from one or more other devices connected to the computing environment 100. An enterprise organization may correspond to any government or private institution, an educational institution, a financial institution, health services provider, retailer, or the like.

As illustrated in greater detail below, the application dependency mapping platform 105 may comprise one or more computing devices configured to perform one or more of the functions described herein. The application dependency mapping platform 105 may comprise, for example, one or more computers (e.g., laptop computers, desktop computers, servers, server blades, or the like).

The computing device(s) 110 may comprise one or more of enterprise application host platforms, an enterprise user computing device, an administrator computing device, and/or other computing devices, platforms, and servers associated with the private network 150. The enterprise application host platform(s) may comprise one or more computing devices and/or other computer components (e.g., processors, memories, communication interfaces). The enterprise application host platform may be configured to host, execute, and/or otherwise provide one or more enterprise applications. The enterprise application host platform(s) may be configured, for example, to host, execute, and/or otherwise provide one or more transaction processing programs, user servicing programs, and/or other programs associated with an enterprise organization. The enterprise application host platform(s) may be configured to provide various enterprise and/or back-office computing functions for an enterprise organization. The enterprise application host platform(s) may comprise various servers and/or databases that store and/or otherwise maintain account information, such as financial/membership account information including account balances, transaction history, account owner information, and/or other information corresponding to one or more users (e.g., external users). The enterprise application host platform(s) may process and/or otherwise execute transactions on specific accounts based on commands and/or other information received from other computer systems comprising the computing environment 100. The enterprise application host platform(s) may transmit and receive data from the application dependency mapping platform 105, and/or to other computer systems in the computing environment 100.

The enterprise user computing device may comprise a personal computing device (e.g., desktop computer, laptop computer) or mobile computing device (e.g., smartphone, tablet). The enterprise user computing device may be linked to and/or operated by a specific enterprise user (e.g., an employee or other affiliate of an enterprise organization).

The administrator computing device may comprise a personal computing device (e.g., desktop computer, laptop computer) or mobile computing device (e.g., smartphone, tablet). The administrator computing device may be linked to and/or operated by an administrative user (e.g., a network administrator of an enterprise organization). The administrator computing device may receive data from the application dependency mapping platform 105, manipulate and/or otherwise process such data, and/or return processed data and/or other data to the application dependency mapping platform 105 and/or to other computer systems in the computing environment 100. The administrator computing device may be configured to control operation of the application dependency mapping platform 105.

The application(s) 130 may comprise transaction processing programs, user servicing programs, and/or other programs associated with an enterprise organization. The application(s) 130 may correspond to applications that provide various enterprise and/or back-office computing functions for an enterprise organization. The application(s) 130 may correspond to applications that facilitate storage, modification, and/or maintenance of account information, such as financial/membership account information including account balances, transaction history, account owner information, and/or other information corresponding to one or more users (e.g., external users). The application(s) 130 may process and/or otherwise execute transactions on specific accounts based on commands and/or other information received from other computer systems comprising the computing environment 100. The application(s) 130 may operate in a distributed manner across multiple computing devices (e.g., the computing device(s) 110) and/or servers, operate on a single computing device and/or server. The application(s) 130 may be used for execution of various operations corresponding to the one or more computing devices (e.g., the computing device(s) 110) and/or servers.

The storage device(s) 120 may comprise various memory devices such as hard disk drives, solid state drives, magnetic tape drives, or other electronically readable memory, and/or the like. The storage device(s) 120 may be used to store data corresponding to operation of one or more applications within the private network 150 (e.g., the application(s) 130), and/or computing devices (e.g., the computing device(s) 110). The storage device(s) 120 may receive data from the application dependency mapping platform 105, store the data, and/or transmit the data to the architecture mapping platform 105 and/or to other computing systems in the computing environment 100.

The architecture of the private network(s) 160 may be similar to an architecture of the private network 150. The private network(s) 160 may correspond to, for example, another enterprise organization that communicates data with the private network 150. The private network 150 may also be linked to the public network 170. The public network 170 may comprise the external computing device(s) 180. The external computer device(s) 180 may include at least one computing device (e.g., desktop computer, laptop computer) or mobile computing device (e.g., smartphone, tablet). The external computer device(s) 180 may be linked to and/or operated by a user (e.g., a client, an affiliate, or an employee) of an enterprise organization associated with the private network 150. The user may interact with one or more enterprise resources while using the external computing device(s) 180 located outside of an enterprise firewall.

The application dependency mapping platform 105, the computing device(s) 110, the external computing device(s) 180, and/or one or more other systems/devices in the computing environment 100 may comprise any type of computing device capable of receiving input via a user interface, and may communicate the received input to one or more other computing devices. The application dependency mapping platform 105, the computing device(s) 110, the external computing device(s) 180, and/or the other systems/devices in the computing environment 100 may, in some instances, comprise server computers, desktop computers, laptop computers, tablet computers, smart phones, wearable devices, or the like that in turn comprise one or more processors, memories, communication interfaces, storage devices, and/or other components. Any and/or all of the application dependency mapping platform 105, the computing device(s) 110, the storage device(s) 120, and/or other systems/devices in the computing environment 100 may be, in some instances, special-purpose computing devices configured to perform specific functions.

Referring to FIG. 2, the application dependency mapping platform 105 may comprise one or more of host processor(s) 106, memory 107, medium access control (MAC) processor(s) 108, transmit/receive (TX/RX) module(s) 109, or the like. One or more data buses may interconnect host processor(s) 106, memory 107, MAC processor(s) 108, and/or TX/RX module(s) 109. The application dependency mapping platform 105 may be implemented using one or more integrated circuits (ICs), software, or a combination thereof, configured to operate as discussed below. The host processor(s) 106 and the MAC processor(s) 108 may be implemented, at least partially, on a single IC or multiple ICs. Memory 107 may be any memory such as a random-access memory (RAM), a read-only memory (ROM), a flash memory, or any other electronically readable memory, or the like.

One or more processors (e.g., the host processor(s) 106, the MAC processor(s) 108, and/or the like) of the application dependency mapping platform 105 may be configured to execute machine readable instructions stored in memory 107. Memory 107 may comprise (i) one or more program modules/engines having instructions that when executed by the one or more processors cause the application dependency mapping platform 105 to perform one or more functions described herein, and/or (ii) one or more databases that may store and/or otherwise maintain information which may be used by the one or more program modules/engines and/or the one or more processors. The one or more program modules/engines and/or databases may be stored by and/or maintained in different memory units of the application dependency mapping platform 105 and/or by different computing devices that may form and/or otherwise make up the application dependency mapping platform 105. For example, memory 107 may have, store, and/or comprise an application dependency mapping engine 107-1, and an application dependency mapping database 107-2. The application dependency mapping engine 107-1 may comprise instructions that direct and/or cause the application dependency mapping platform 105 to perform one or more operations, as discussed in greater detail below. The application dependency mapping database 107-2 may comprise a SQL database, an Oracle database, or another relational database, for example. The application dependency mapping database 107-2 may store information to be used for performing architecture mapping of an application. The application dependency mapping database 107-2 may store information corresponding to the computing device(s) 110, the storage device(s) 120, the application(s) 130, the private networks 150 and 160, the public network 170, and/or the external computing device(s) 180 operating within the computing environment 100 for performing the application dependency mapping of the application. The host processor(s) 106 may use the application dependency mapping database 107-2 to store, identify, and/or retrieve the information to be used for performing application dependency mapping. The application dependency mapping database 107-2 may be updated based on performance of the application dependency mapping, as discussed in greater detail below.

While FIG. 2 illustrates the application dependency mapping platform 105 as being separate from other elements connected in the private network 150, in one or more other arrangements, the application dependency mapping platform 105 may be included in one or more of the computing device(s) 110, and/or other device/servers associated with the private network 150. Elements in the application dependency mapping platform 105 (e.g., host processor(s) 106, memory(s) 107, MAC processor(s) 108, and TX/RX module(s) 109, one or more program modules and/or stored in memory(s) 107) may share hardware and/or software elements with and corresponding to, for example, one or more of the computing device(s) 110, and/or other device/servers associated with the private network 150.

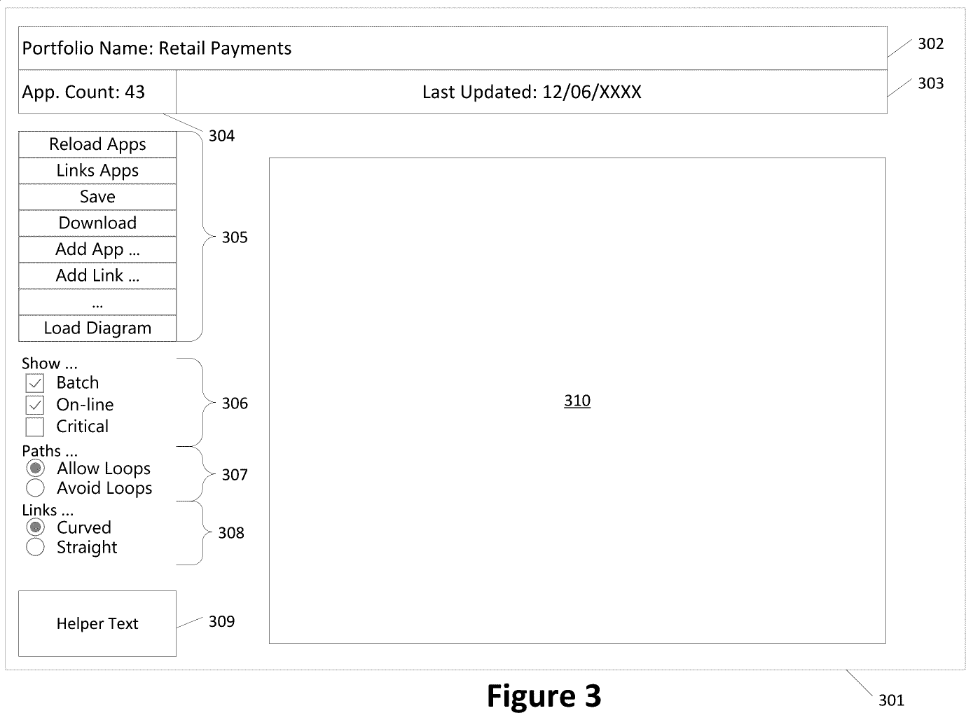

FIG. 3 depicts an exemplary user interface feature selection background 301 that may be used in accordance with various aspects of the disclosure. In an aspect of the disclosure, the exemplary user interface feature selection background 301 may be part of a webpage frame. In an embodiment, user interface controls may be displayed on the left side of user interface feature selection background 301.

In FIG. 3, a retail payments service 302 may be selected for dependency mapping by application dependency mapping platform 105. Application dependency mapping platform 105 may extract data from enterprise database systems and determine application data and information flow data related to retail payments service 302 applications. In an embodiment, the determined application data and information flow data may be analyzed and processed into a JSON data structure. A graphical library may be loaded and executed by application dependency mapping platform 105 for use in rendering a webpage displaying the retail payments service applications and their related dependency mapping.

In an embodiment, application dependency mapping platform 105 may generate an application dependency diagram showing interconnections between applications used in the retail payments service 302. The application dependency mapping diagrams may be displayed in area 310 of user interface feature selection background 301. The user interface feature selection background 301 of FIG. 3 may indicate the last update for the displayed application dependency mapping diagram at 303. Additionally, user interface feature selection background 301 may indicate the number of applications 304 that may be displayed in the mapping diagram for retail payments.

In some arrangements, user interface feature selection background 301 may include a number of diagram controls 305 and a number of visualization controls 306. In an embodiment, diagram controls may include a reload application feature, a link application feature, a save feature, a download feature, an add application feature, an add a link feature, a load diagram feature, and numerous other diagram control features.

User interface feature selection background 301 may also include visualization controls that allow user selection of different types of applications to be displayed in dependency mapping diagrams. For instance, in some arrangements only batch applications may be displayed. In other arrangements, only on-line applications may be displayed. In yet other arrangements, both batch and on-line applications may be displayed. In some arrangements, critical applications may also be displayed and highlighted in application dependency mapping diagrams.

Additional visualization controls may include displaying application loops. The application loops may display all of the dependencies an application has with other applications (i.e. multiple back and forth arrangements). In an embodiment, these loops may be hidden to make the diagram clearer and readable. When not displayed, loop information may still be available by selecting the application to activate drill down menus having detailed information for each application. In some arrangements, user interface feature selection background 301 may also include display link preferences such as using curved lines or straight lines to illustrate application dependencies. User interface feature selection background 301 may also include a help text box 309 which displays useful information for working with application dependency mapping platform 105.

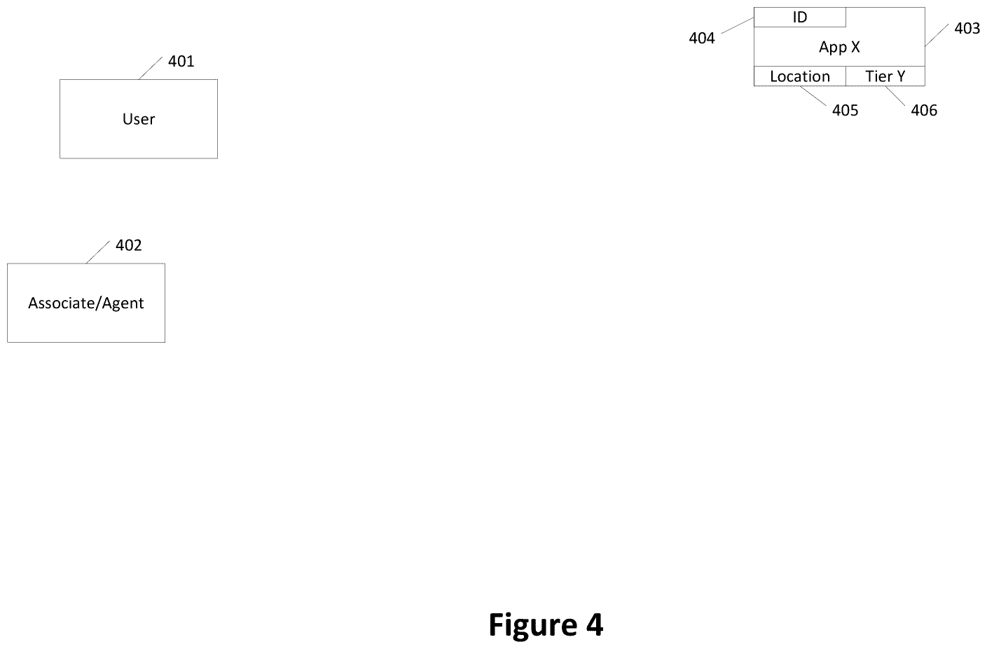

FIG. 4 illustrates an exemplary application template that may be used in accordance with various aspects of the disclosure. In an embodiment, application template 403 for an application X illustrates an application whose dependency may be shown in relation to a user 401 or associate/agent 402. In some arrangements, application template 403 for application X may include various elements such as an asset identification number 404, a platform type 405, and a recovery tier 406. The asset identification number 404 may allow an organization to track numerous applications across an enterprise. The asset identification number may be a unique number assigned to each application. Platform type 405 for each application may list a location of where an application is found in a hierarchy within an enterprise or organization. For instance, an application may be a middleware application, a desktop application, a mainframe application and/or a third-party application. The recovery tier status 406 of an application may indicate the criticality of an application. For instance, a Tier 0 application may be an application that must always be continuously available for execution. In an embodiment, it may be a requirement for a Tier 0 application to have all dependencies with other applications determined and displayed by application dependency mapping platform 105. In one exemplary instance, applications may have recovery tier designations that range from Tier 0 level to Tier 5.

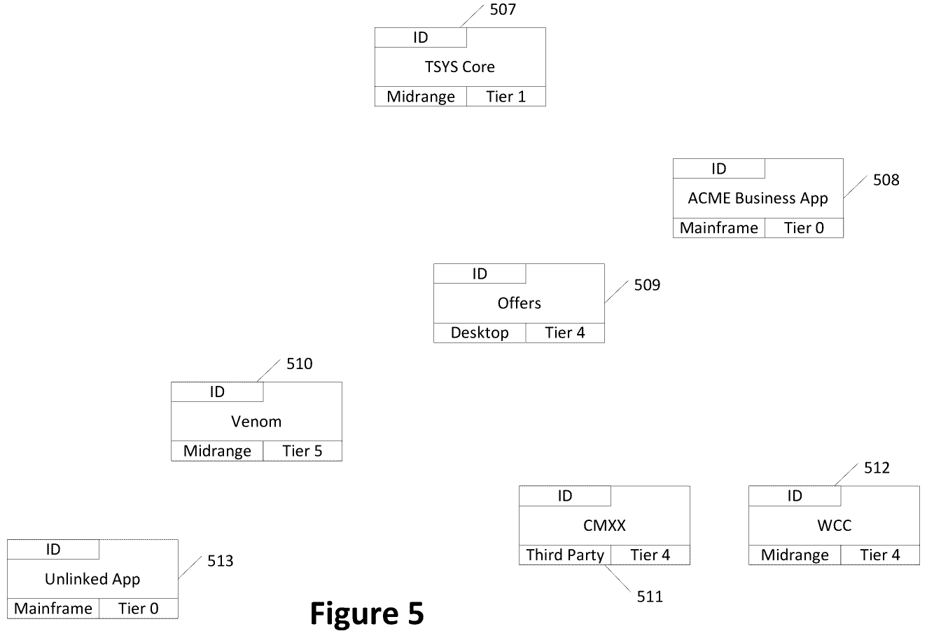

FIG. 5 illustrates additional exemplary application templates that may be used in accordance with various aspects of the disclosure. For instance, FIG. 5 illustrates midrange application templates 507, 510, and 512. Application templates 508 and 513 represent mainframe templates. Applications 507 and 512 represent midrange templates. Application 509 illustrates a desktop application. Each of the application templates may provide the applications short description name such as “Venom”, “TSYS Core”, “ACME Business App”, “Offers”, “CMXX”, and “WCC”. In an embodiment, selection of the short description name (or hovering over it) may reveal the full name of the application along with additional application details.

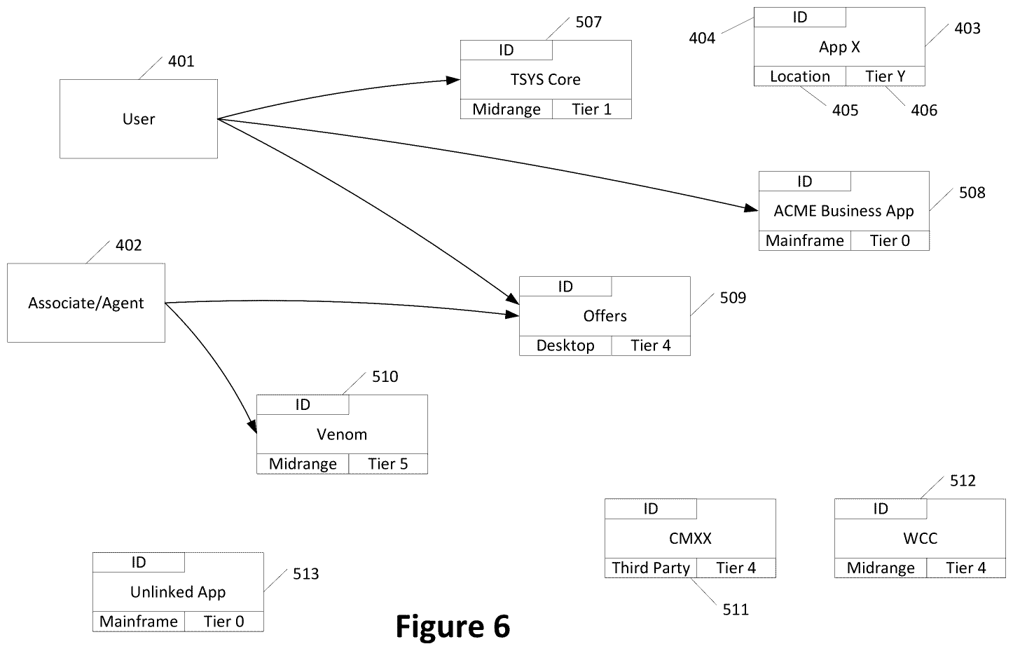

FIG. 6 illustrates exemplary determined application dependencies between users and applications in accordance with various aspects of the disclosure. For instance, FIG. 6 illustrates an application dependency between user 601 and “Offers” application template 609. In an aspect of the disclosure, the application templates may be moved or rearranged on the user interface to display alternative layouts based on preferences. For example, dependencies between user 601 and associate/agent 602 may be shown in a left to right progression across area 310 of user interface feature selection background 301. In some arrangements, user 601 and associate/agent 602 may be moved by selecting and dragging their application template boxes to other locations in area 310. Once moved the dependencies may be redrawn on the user interface to account for the relocation.

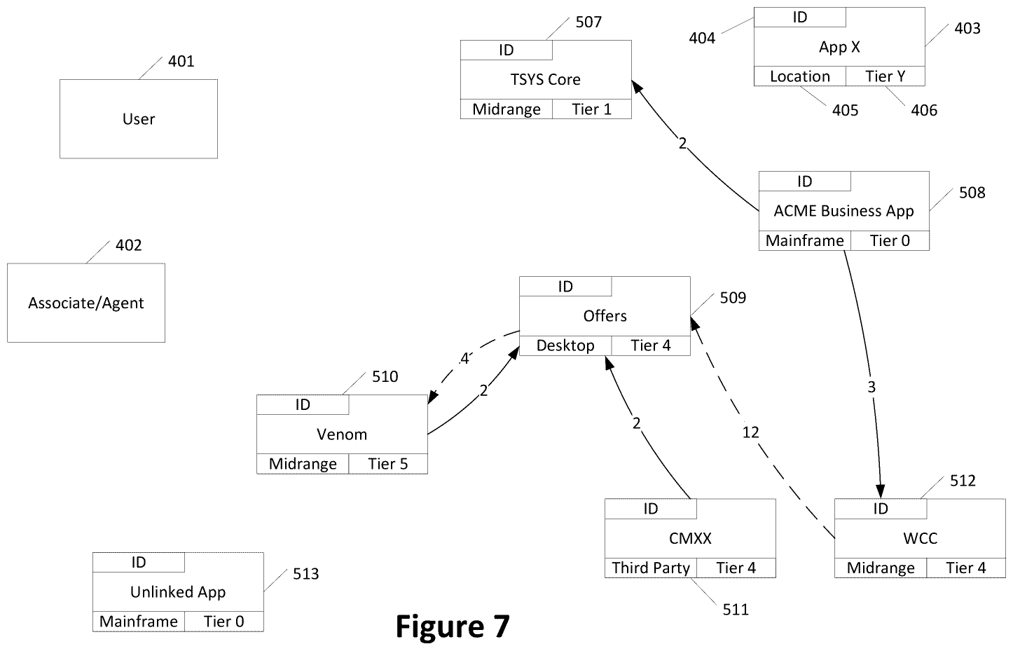

FIG. 7 illustrates exemplary determined application dependencies between applications in accordance with various aspects of the disclosure. For instance, FIG. 7 illustrates an application dependency between application template 708 and application template 707. As shown in FIG. 7 by the line between application template 708 and 707 two dependencies between the applications have been determined. For drawing clarity only one line is displayed on the dependency diagram. Additional information about each of the two dependencies between application template 708 and 707 may be displayed upon selection of the line drawn between application template 708 and 707 (or hovering over it). In some arrangements, dotted lines between application templates may represent batch process dependencies between applications. For instance, FIG. 12 illustrates twelve batch process application dependencies between application templates 712 and 709.

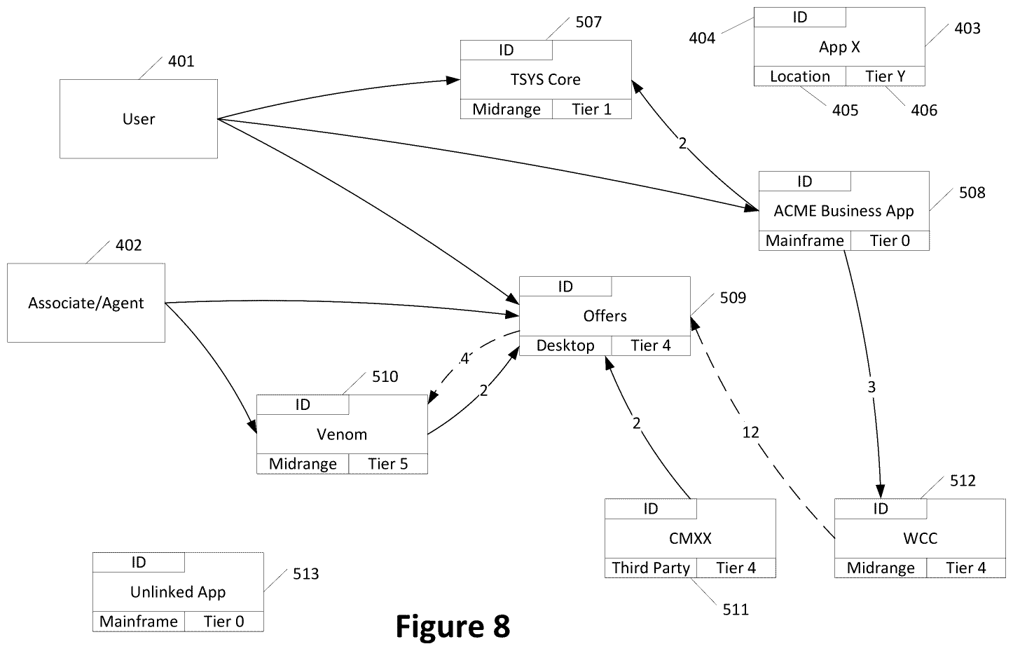

FIG. 8 illustrates a dependency diagram showing all dependencies between applications and users in accordance with various aspects of the disclosure. In an embodiment, FIG. 8 may be displayed in area 310 of user interface feature selection background 301 (shown in FIG. 3). As discussed with respect to FIG. 3, user interface controls may be displayed on the left side of user interface feature selection background 301 and used to modify the displayed dependency diagram. FIG. 8 also illustrates that some applications may be standalone applications having no dependencies such as unlinked application template 513. Such applications may still be shown on dependency diagrams as they are still applications included in the selected service. In another embodiment, an application that does not display any dependencies may indicate that a data flow problem exists.

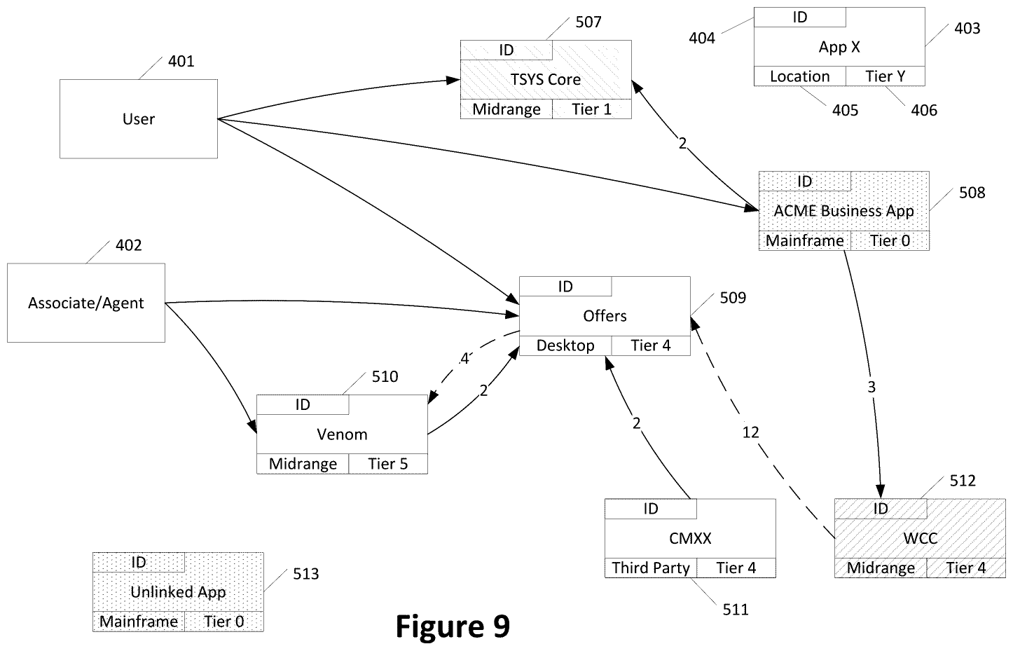

FIG. 9 illustrates using styles and colors to highlight features of similar applications in accordance with various aspects of the disclosure. For instance, FIG. 9 illustrates recovery Tier 0 applications 508 and 513 having a highlighted colored background. This may allow a user to quickly identify all critical applications. Similarly, all midrange applications such as applications 507 and 512 may be highlighted for easy identification. Those skilled in the art will realize that important similar features of application may be highlighted based on enterprise preferences.

In some aspects of the disclosure, detector probes may be configured and initiated to identify application flows between applications. The detector probes may be configured according to a computing environment in which the application executes and/or in which the detector probes are deployed. The detector probes may be configured to execute in a Java runtime environment, a mainframe computing system environment, or any combination of types of computing systems, operating systems, computing networks, or database systems, for example.

In an embodiment, a machine learning algorithm may analyze application flows to determine application dependencies in accordance with an aspect of the disclosure. Machine learning may be performed based on one or more dependencies diagrams with data input into the dependency diagram by one or more detector probes.

In an embodiment, the machine learning algorithm may incorporate user feedback regarding the determined application dependencies and mapped dependency diagrams. Results from the machine learning may be used to update the dependency mapping for improved accuracy in determining application dependencies.

In an embodiment, an application dependency database may store all determined application dependency diagrams. The application dependency database may be updated for any or each completed iteration of dependency application determination.

In another aspect of the disclosure, application dependency diagrams may be compared to each other for different selected services. The compared application dependency diagrams may be analyzed to determine how and where to combine different services. In an embodiment, a compatibility score may be generated and utilized in combing a first application service with a second application service. The analysis may provide insights into utilization of different application and method for improving application speed of execution within services.

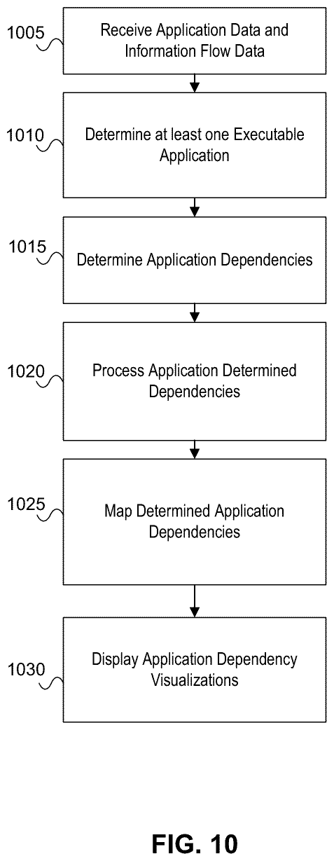

FIG. 10 depicts a process flow for generating application dependency diagrams in accordance with one or more example arrangements. In FIG. 10 at step 1005, the application dependency mapping platform 105 may receive application data and information flow data for an application service. In step 1010, application dependency mapping platform 105 may determine at least one executable application included in the application service based on the received data and information flow data. Next, in step 1015, application dependency mapping platform 105 may determine dependencies based on the analyzed application data and information flow data for the determined at least one executable application. In step 1020, application dependency mapping platform 105 may process the determined dependencies into a JSON data structure. Application dependency mapping platform 105 may in step 1025 map the determined application dependencies using a graphical library. In step 1030, application dependency mapping platform 105 may display the application dependency visualizations on a user interface of a display device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various examples. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware example, an entirely software example, an entirely firmware example, or an example combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative examples thereof. Numerous other examples, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive application data and information flow data for a first application service;
determine based on the received application data and information flow data, at least one executable application included in the first application service;
determine dependencies based on the analyzed application data and information flow data for the determined at least one executable application;
determine a first visual representation of the determined application dependencies for the first application service;
compare the first visual representation of the determined application dependencies for the first application service to a second visual representation of a second application service stored in memory; and
determine based on the comparison a compatibility score for combining the first application service with the second application service.

2. The computing platform of claim 1, wherein the memory further stores computer-readable instructions that, when executed by the at least one processor, cause the computing platform to: receive a selection of the first application service.

3. The computing platform of claim 1, wherein the memory further stores computer-readable instructions that, when executed by the at least one processor, cause the computing platform to: render a webpage frame including the first visual representation of the first application service and the second visual representation of the second application service.

4. The computing platform of claim 3, wherein the memory further stores computer-readable instructions that, when executed by the at least one processor, cause the computing platform to: display the webpage frame on a user interface of a display device.

5. The computing platform of claim 4, wherein the webpage frame includes controls for operating features of displayed user interface.

6. The computing platform of claim 4, wherein the webpage frame includes visualization controls for displaying different features of the displayed first visual representation and the second visual representation.

7. The computing platform of claim 6, wherein the memory further stores computer-readable instructions that, when executed by the at least one processor, cause the computing platform to: remove batch processes from the displayed first visual representation and the second visual representation.

8. The computing platform of claim 1, wherein the memory further stores computer-readable instructions that, when executed by the at least one processor, cause the computing platform to:
perform machine learning on the determined first visual representation based on additional information flow data for the first application service; and
update, based on the machine learning, the determined first visual representation for the first application service.

9. A method comprising:
receiving application data and information flow data for a first application service;
determining based on the received data and information flow data, at least one executable application included in the first application service;
determining dependencies based on the analyzed application data and information flow data for the determined at least one executable application;
determining a first visual representation of the determined application dependencies for the first application service;
comparing the first visual representation of the determined application dependencies for the first application service to a second visual representation of a second application service stored in memory; and
determining based on the comparison a compatibility score for combining the first application service with the second application service.

10. The method of claim 9, further comprising receiving a selection of an application service.

11. The method of claim 9, further comprising rendering a webpage frame including the first visual representation of the first application service and the second visual representation of the second application service.

12. The method of claim 11, further comprising displaying the webpage frame on a user interface of a display device.

13. The method of claim 12, wherein the user interface includes controls for operating features of displayed user interface.

14. The method of claim 12, wherein the webpage frame includes visualization controls for displaying different features of the displayed first visual representation and the second visual representation.

15. The method of claim 9, further comprising:
performing machine learning on the determined first visual representation based on additional information flow data for the first application service; and
updating, based on the machine learning, the determined visual representation for the first application service.

16. One or more non-transitory computer-readable media storing instructions that, when executed by a computing platform comprising at least one processor, a communication interface, and memory, cause the computing platform to:
receive application data and information flow data for a first application service;
determine based on the received application data and information flow data, at least one executable application included in the first application service;
determine dependencies based on the analyzed application data and information flow data for the determined at least one executable application;
determine a first visual representation of the determined application dependencies for the first application service;
compare the first visual representation of the determined application dependencies for the first application service to a second visual representation of a second application service stored in memory; and
determine based on the comparison a compatibility score for combining the first application service with the second application service.

17. The one or more non-transitory computer-readable media of claim 16, further comprising instructions when executed cause computing platform to: receive a selection of the first application service.

18. The one or more non-transitory computer-readable media of claim 16, further comprising instructions when executed cause computing platform to: render a webpage frame including the first visual representation of the first application service and the second visual representation of the second application service.

19. The one or more non-transitory computer-readable media of claim 18, further comprising instructions when executed cause computing platform to: display the webpage frame on a user interface of a display device.

20. The one or more non-transitory computer-readable media of claim 16, further comprising instructions when executed cause computing platform to:
perform machine learning on the determined first visual representation based on additional information flow data for the first application service; and
update, based on the machine learning, the determined first visual representation for the first application service.
